(19) United States
(12) Patent Application Publication
(10) Pub. No.: US 2016/0154802 A1
(43) Pub. Date: Jun. 2, 2016

(54) QUALITY CONTROL ENGINE FOR COMPLEX PHYSICAL SYSTEMS

(71) Applicant: NEC Laboratories America, Inc., Princeton, NJ (US)

(72) Inventors: Tan Yan, Bedminster, NJ (US); Guofei Jiang, Princeton, NJ (US); Haifeng Chen, Old Bridge, NJ (US); Mizoguchi Takehiko, Tokyo (JP)

(21) Appl. No.: 14/956,352

(22) Filed: Dec. 1, 2015

Related U.S. Application Data
(60) Provisional application No. 62/086,301, filed on Dec. 2, 2014.

(51) Int. Cl. G06F 17/30

(52) U.S. Cl. CPC G06F 17/3053; G06F 17/30551; G06F 17/30554

(57) ABSTRACT

Systems and methods for quality control for physical systems, including a quality control engine for transforming raw time series data collected from each of a plurality of sensors in the physical system into one or more sets of feature series by extracting features from the raw time series. Feature ranking scores are generated for each of the sensors by ranking each of the features using an ensemble of feature rankers, and fused importance scores are generated by aggregating the feature ranking scores for each of the sensors and combining ranking scores from each ranker in the ensemble. System quality is controlled by identifying sensors responsible for quality degradation based on the fused importance scores.

### RELATED APPLICATION INFORMATION

This application claims priority to provisional application Ser. No. 62/086,301 filed on Dec. 2, 2014, incorporated herein by reference in its entirety.

### BACKGROUND

1. Technical Field

The present invention relates to the management of physical systems, and, more particularly, to a quality control engine for management of complex physical systems.

2. Description of the Related Art

With the decreasing hardware cost and increasing demand for autonomic management, many physical systems nowadays are equipped with a large network of sensors distributed across different parts of the system. The readings of sensors are continuously collected time series, which monitor the operational status of physical systems. Current systems and methods compare the record of sensor readings with the system key performance indicator (KPI) using statistical tests. They test each sensor individually to discover the most suspicious sensors. With a large number of sensors in the systems, such methods are not efficient. More importantly, they ignore the dependencies between different sensor readings, which may miss important sensors. In addition, current methods only consider the raw values of sensor readings, rather than discover the underlying patterns from the readings. As a consequence, the final results will not be accurate.

There are several challenges to discover suspicious sensors for quality control. Firstly, there are a massive amount of sensors in the system and the data collected from these sensors can be correlated. It is impossible to manually check sensors one by one to obtain the importance list. Secondly, data collected from different sensors can also demonstrate different behaviors due to the diversities in system components and their functionalities. For example, while some sensors directly change their raw values in the case of quality changes, others sensors may exhibit significant frequency changes in their readings. It is not possible to use a uniform feature to capture the dynamics of the time series from all sensors. Moreover, the dependencies between sensor data and system operational status are highly nonlinear. For instance, a hidden fault in one component usually undergoes a sequence of nonlinear physical processes before affecting the final production quality. As a consequence, the final using conventional systems and methods are not accurate.

### SUMMARY

A method for quality control for physical systems, including transforming raw time series data collected from each of a plurality of sensors in the physical system into one or more sets of feature series by extracting features from the raw time series. Feature ranking scores are generated for each of the sensors by ranking each of the features using an ensemble of feature rankers, and fused importance scores are generated by aggregating the feature ranking scores for each of the sensors and combining ranking scores from each ranker in the ensemble. System quality is controlled by identifying sensors responsible for quality degradation based on the fused importance scores.

A quality control engine for a physical system, including a time series transformer for transforming raw time series data collected from each of a plurality of sensors in the physical system into one or more sets of feature series by extracting features from the raw time series. An ensemble of feature rankers is configured to rank each of the features to generate feature ranking scores for each of the sensors, and a combiner generates fused importance scores by aggregating the feature ranking scores for each of the sensors and fusing ranking scores from each ranker in the ensemble. A controller manages system quality by identifying sensors responsible for quality degradation based on the fused importance scores.

A computer-readable storage medium including a computer-readable program, wherein the computer-readable program when executed on a computer causes the computer to perform the steps of transforming raw time series data collected from each of a plurality of sensors in the physical system into one or more sets of feature series by extracting features from the raw time series. Feature ranking scores are generated for each of the sensors by ranking each of the features using an ensemble of feature rankers, and fused importance scores are generated by aggregating the feature ranking scores for each of the sensors and combining ranking scores from each ranker in the ensemble. System quality is controlled by identifying sensors responsible for quality degradation based on the fused importance scores.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system to which the present principles may be applied, in accordance with an embodiment of the present principles;

FIG. 2 shows a high level diagram of an exemplary complex physical system including a quality control engine, in accordance with an embodiment of the present principles;

FIG. 3 shows exemplary time series graphs for a key performance indicator (KPI) and related raw time series, in accordance with an embodiment of the present principles;

FIG. 4 shows an exemplary method for quality control for physical systems using a quality control engine, in accordance with an embodiment of the present principles;

FIG. 5 shows an exemplary key performance indicator (KPI) time series for a real-world biochemical plant, in accordance with an embodiment of the present principles; and

FIG. 6 shows an exemplary system for quality control for physical systems using a quality control engine, in accordance with an embodiment of the present principles.

### DETAILED DESCRIPTION OF PREFERRED EMBODIMENTS

The present principles provide a system and method for management of complex physical systems using a quality control engine according to various embodiments. In a particularly useful embodiment, the present principles may employ a general framework for quality control in physical systems, which utilize several machine learning techniques (e.g., feature selection and ranking, information fusion, etc.) to achieve automatic and accurate sensor localization. Given the time series data from a sensor, the data may be transformed into a number of different feature series.

In one embodiment, these features may come from a pre-defined library that includes a large number of feature definitions so as to describe different aspects of the signal dynamics, and may also be determined based on, for example, system dynamics. As a result of transformation, a large number of feature series may be obtained based on the raw time series collected from sensors (e.g., deployed in the physical system(s)). The importance of all these feature series may be ranked with respect to the system quality, by utilizing several feature selection techniques (e.g., a regularization based ranker, a tree based ranker, a localized nonlinear ranker, etc.).

In some embodiments, several rankers may be adopted together (e.g., fused) to cover different views of feature importance and their dependencies in the huge feature space, including both linear and nonlinear relationships. A ranking score fusion, which may combine the ranked output from all rankers, as well as the ranking scores of each sensor. As the output, a final ranking of sensors that can be used to explain the quality change may be generated according to the present principles.

In an embodiment, measured/received sensor data may be leveraged to control the quality of physical systems (e.g., manufacturing systems). The output quality of practical manufacturing systems may be controlled by human operations, and although in many cases the system can generate good products, the quality of product may drop under certain conditions (e.g., not detectable or controllable by human operations), which directly affects the manufacturing profits. Therefore, it is important to discover the hidden conditions that lead to quality degradations so that the system may be adjusted quickly (e.g., in real time) to avoid future losses. In one embodiment, quality control may be achieved by analyzing the data from deployed sensors to locate suspicious sensors that lead to the quality changes, thereby quickly pinpointing the root cause of quality degradation so that the system operation may be improved (e.g., in real time) according to the present principles.

The present principles may produce high quality (e.g., highly accurate) results which pinpoint the sensors that lead to system quality degradation. Such an accuracy enhancement will lower the operational cost and generate high revenues in physical systems. In addition, the output according to the present principles can also be employed for problem debugging, which, for example, advantageously lowers latency in addressing system problems according to various embodiments.

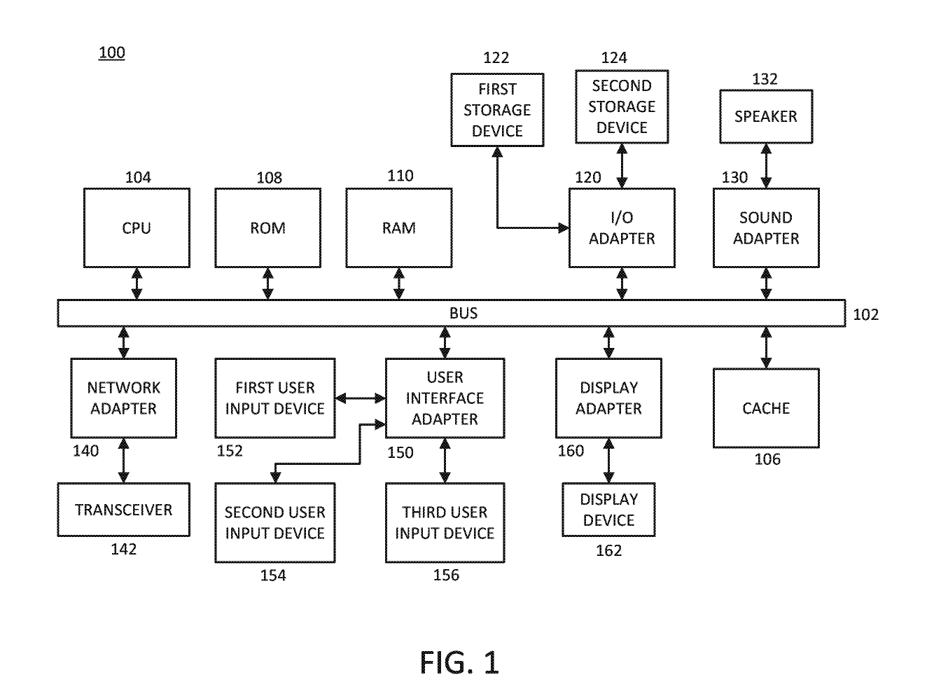

Referring now to the drawings in which like numerals represent the same or similar elements and initially to FIG. 1, an exemplary processing system 100, to which the present principles may be applied, is illustratively depicted in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

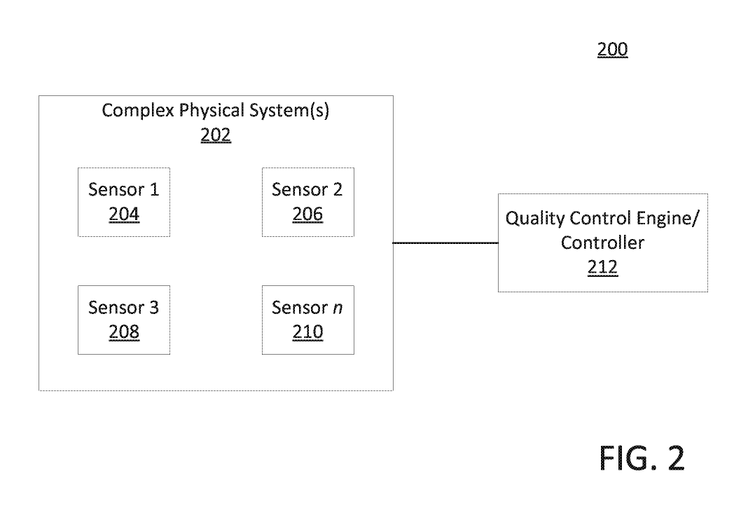

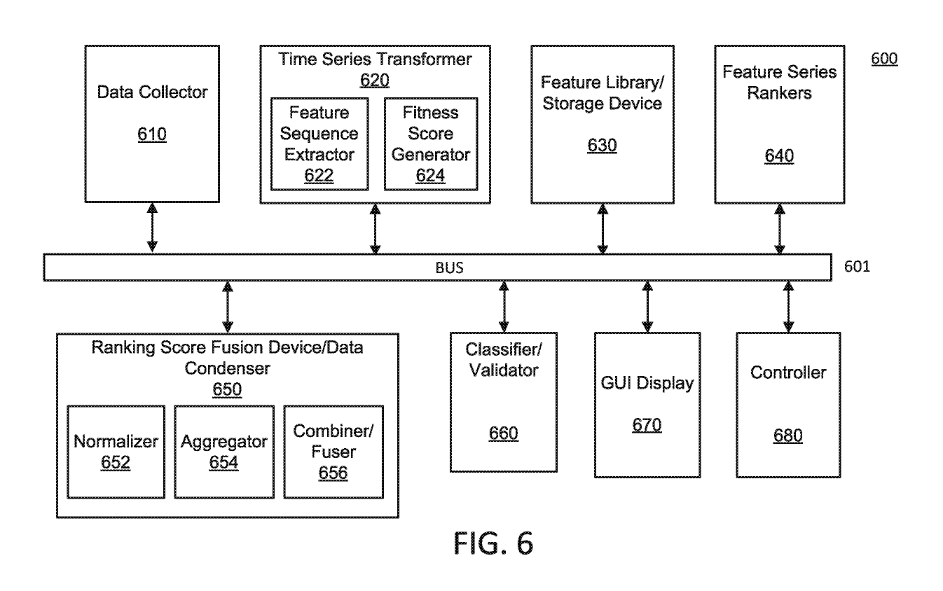

Moreover, it is to be appreciated that circuits/systems/networks 200 and 600 described below with respect to FIGS. 2 and 6 are circuits/systems/networks for implementing respective embodiments of the present principles. Part or all of processing system 100 may be implemented in one or more of the elements of systems 200 and 600 with respect to FIGS. 2 and 6.

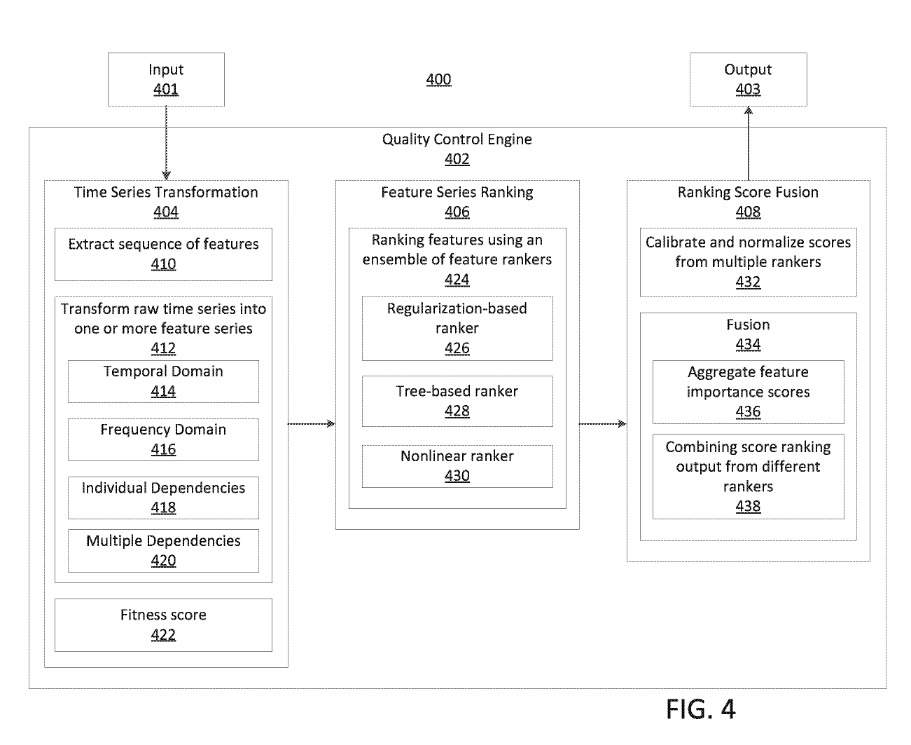

Further, it is to be appreciated that processing system 100 may perform at least part of the methods described herein including, for example, at least part of method 400 of FIG. 4. Similarly, part or all of circuits/systems/networks 200 and 600 of FIGS. 2 and 6 may be used to perform at least part of the methods described herein including, for example, at least part of method 400 of FIG. 4.

Referring now to FIG. 2, a high level schematic 200 of an exemplary complex physical system including a quality control engine is illustratively depicted in accordance with an embodiment of the present principles. In one embodiment, one or more complex physical systems 202 may be controlled and/or monitored using a quality control engine 212 according to the present principles. The physical systems may include a plurality of sensors 204, 206, 208, 210 (e.g., sensors 1, 2, 3, . . . n), for detecting/measuring various system devices/processes.

In one embodiment, sensors 204, 206, 208, 210 may include any sensors now known or known in the future for monitoring physical systems (e.g., temperature sensors, pressure sensors, key performance indicator (KPI), pH sensors, etc.), and the data from the sensors may be employed as input to the quality control engine 212 according to the present principles. The quality control engine may be directly connected to the physical system or may be employed to remotely control the quality of the system according to various embodiments of the present principles, and the quality control engine will be described in further detail herein below.

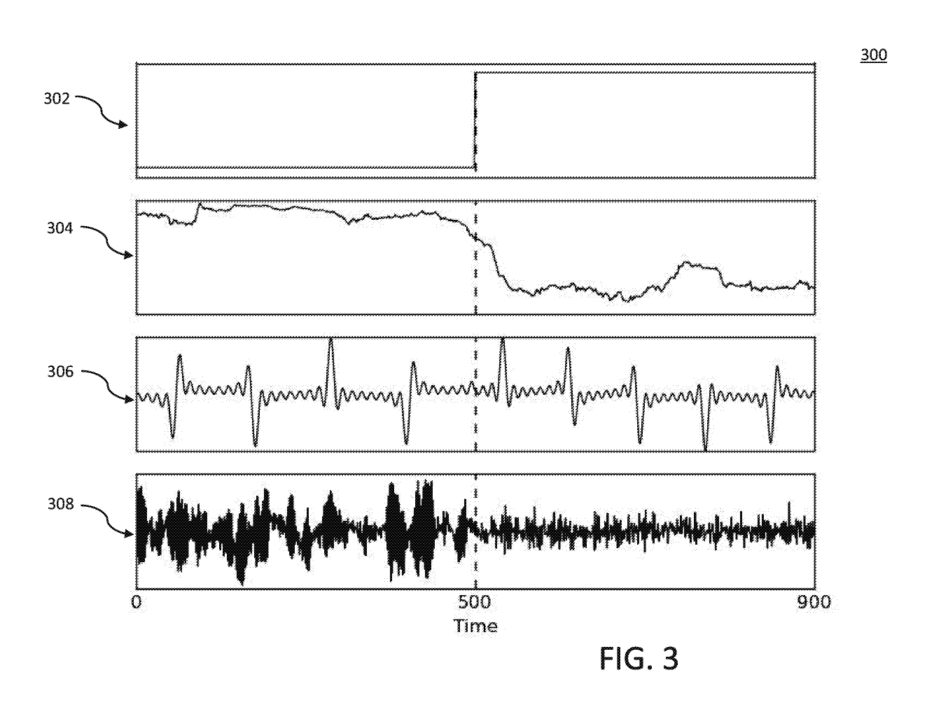

Referring now to FIG. 3, exemplary time series graphs 300 for a key performance indicator (KPI) and related raw time series are illustratively depicted in accordance with an embodiment of the present principles. In one exemplary embodiment, given n sensors in a system, n time series x₁ (t), . . . , xₙ (t) may be obtained, where t=1, . . . , T is the system operation period. During that period, the quality of the system is represented by y(t), t=1, . . . , T. Generally, y(t) can be obtained by a special sensor called ‘key performance indicator’ (KPI) in the system, represented by time series 302. Based on the value of KPI 302, system operations may be divided into good-quality regions and bad-quality regions, and various time series xᵢ (t) may be ranked (e.g., based on their contributions to the system quality change) according to the present principles.

In some embodiments, system quality changes may be triggered by the variances of underlying physical operations, which may be in turn represented by changes of the dynamics of related sensor readings. However, the dynamics of different time series are generally represented in different ways. For example, in time series 302 the quality changes may be inferred directly from raw values of that time series, whereas for sensor in time series 304, the frequency distribution in the readings is relevant. For the time series 306, the change of its temporal dependencies may explain the KPI changes.

For example, in the good-quality region, the time series may have a dependency relation x(t)=f(x(t−1), x(t−2), . . . ) whereas in the bad-quality region the relation may change to x(t)=g(x(t−1), x(t−2), . . . ), where f(•)=g(•). It is noted that there are a plurality of additional types of features to represent the evolution of time series, but for simplicity of illustration, only the above time series are presented as examples. In some embodiments, a library of features that may interpret a variety of time series evolution patterns may be constructed according to the present principles, and the library will be described in further detail herein below. In some embodiments, these feature definitions may be gleaned from the feedback of system domain experts, and/or may be determined using the quality control engine according to the present principles.

Given the feature definitions in the library (e.g., F₁, . . . , Fₘ), it may still be not known which feature is the correct one for an individual time series. In some embodiments, the raw time series 304, 306, 308 may be transformed into one or more candidate feature series (e.g., x(t)→{x^{F}^{₁} (t) . . . x^{F}^{ₘ} (t)}), and one or more feature selection techniques in machine learning may be employed according to the present principles to automatically rank these features according to their relationship to the quality change. In practice, we usually encounter a huge feature space when the number of time series n is large, since we will have altogether (m+1)n feature candidates (e.g., including raw time series as well as their feature series). It is not trivial to rank these features in a stable way given such a large feature space. Furthermore, the dependencies between features and the system quality can be highly nonlinear.

In one embodiment, to address these issues, an ensemble of feature rankers may be employed. These rankers may include, for example, a regularization based feature ranker, a tree based feature ranker, and/or a RELIEFF feature ranker, although other rankers may also be employed according to the present principles. In some embodiments, individual rankers may produce/determine different subsets of important features than other rankers according to the present principles.

For example, the regularization based ranker may focus on the regression based relationship between features and the system quality, the tree based ranker may employ information theory based criteria to detect important features, and the RELIEFF based ranker may look at each local region to detect nonlinear relationships. By combining (e.g., fusing) the power of various rankers, a complete and stable ranking may be determined from a large feature space according to the present principles.

In some embodiments, after feature transformation and ranking based on one or more time series 302, 304, 306, 308, all ranking results may be combined (e.g., ranking score fusion) to obtain the final ranked list of suspicious sensors. This process covers a two dimensional view of ranking score fusion. Firstly, since the final output may be the ranking of sensors (e.g., the raw time series), all the feature ranking scores may be aggregated for each raw time series. Secondly, the output of different rankers may be combined to determine an overall ranking score. By combining both dimensions of ranking scores, the final ranked list of sensors based on their contribution to the system quality change may be determined according to the present principles. The transformation, rankers, and the fusion of various rankers will be described in further detail herein below.

Referring now to FIG. 4, an exemplary method 400 for quality control for physical systems using a quality control engine is illustratively depicted in accordance with an embodiment of the present principles. In one embodiment, data from a plurality of sensors (e.g., in a complex physical system) may be monitored, measured, and/or received as input to a quality control engine 402. The quality control engine 402 may perform time series transformation 404, feature series ranking 406, and ranking score fusion 408 according to various embodiments of the present principles.

In one embodiment, input 401 (e.g., sensor data, time series, etc.) may be received by the quality control engine 402, and output 403 may be generated from the quality control engine 402 according to the present principles. Data from different sensors may exhibit different dynamics with respect to the system operation. Such dynamics which may be received as input 401 can be different shapes, frequencies, scales, etc. In order to handle these heterogeneous behaviors, time series collected from each sensor may be transformed in block 404 into a set of feature series according to the present principles. These features may cover various aspects of the dynamics of raw time series, and can then be used to localize sensors that contribute to quality changes.

In one embodiment, in block 410, feature extraction from one or more time series may be performed using a sliding window technique. This technique may be employed to extract feature from time series while preserving continuity along the time axis. As an illustrative example, consider the feature extraction from a specific time series xi(t), where i=1, . . . , n is the index of time series and t=1, . . . , T is the time stamp. The width of the window is denoted as w.

If the series starts from t=tₗ, where tₗ₌₁, . . . , T−w+1, then we obtain a subsequence of width w, (e.g., xᵢ(tₗ), xᵢ(tₗ+1), . . . , xᵢ(tₗ+w−1) and a potential feature value [symbol] (tₗ) may be extracted from the subsequence:

{xᵢ(tₗ),xᵢ(tₗ+1), . . . , xᵢ(tₗ+w−1)}→ [symbol] (tₗ) (1),

where Fj represents the jth feature in the pre-defined feature library F. The feature [symbol] (tₗ) may be extracted from xᵢ(t) for all possible l and obtain the corresponding feature time series with length T−w+1 (e.g., [symbol] (1), [symbol] (2), . . . , [symbol] (T−w+1)). The present principles may be employed to extract m feature sequences as defined in the feature library F1, . . . , Fm for each time series xᵢ(t), where (i=1 . . . , n), which may result in having totally (m+1)*n series including the raw time series.

In block 412, raw time series may be transformed into one or more feature series to cover various aspects of the dynamics of sensor readings, which may include, for example, characteristics of time series in the temporal domain 414, characteristics of time series in the frequency domain 416, temporal dependencies of individual time series 418, and dependencies across different time series 420 according to various embodiments of the present principles.

In one embodiment, the sliding window technique may be employed to transform each raw time series into a number of feature series. An exemplary list of features implemented in the quality control engine 402 is presented for illustrative purposes in Table 1, below, although any features may be employed according to various embodiments of the present principles.

TABLE 1
Examples of Features

| feature type | feature name | token |
|---|---|---|
| basic statistics | mean | mean |
| | standard deviation | std |
| | skewness | skew |
| | kurtosis | kurt |
| | 5% quantile | qt05 |
| | 95% quantile | qt95 |
| frequency distribution | maximum of porwer spectrum | Fmax |
| | frequency of Fmax | FmxLoc |
| | power in the n-th window | PinBinn |
| AR coefficients | coefficient of n-th past point | ARpn |
| | constant of AR model | ARcons |
| | AIC of the regiression result | ARaic |
| pairwise correlation | correlation of two subsequences | corr |
| original time series | original time series itself | org |

In some embodiments, the above feature may cover aspects of time series properties of, for example, characteristics of time series in the temporal domain 414, characteristics of time series in the frequency domain 416, temporal dependencies of individual time series 418, and dependencies across different time series 420 according to the present principles. In block 414, with respect to characteristics of time series in the temporal domain, basic statistics may be extracted from one or more time series to reflect the shape of its evolution, which may include, for example, mean, standard deviation, and some high order moments of the subsequence within each sliding window. In some embodiments, the 5% and 95% quantile of the value distribution in the sliding window may also be computed according to the present principles. In some embodiments, different features may be extracted for a same time series, as different features may capture different dynamics of time series behaviors.

In block 416, with respect to characteristics of time series in the frequency domain, a Fast Fourier Transform (FFT) may be applied to the subsequences, and may use information from the power spectral density as features. For example, the power and location of the most dominant frequency may be employed as features. In some embodiments, the frequency region may be divided into different bands, and the sum of a power spectrum in each band may be computed as the feature.

In block 418, with respect to temporal dependencies of individual time series, an auto-regressive (AR) model may be employed to describe this property, and the coefficients of the AR model may be used as features. It is noted that not all time series have strong temporal dependencies. In one embodiment, the Akaike's information criterion (AIC) score may be computed as the goodness of the AR model. If the score is always low over time, the AR related features for that time series may be ignored according to the present principles.

In block 420, with respect to dependencies across different time series, the present principles may be employed to extract features from two or more time series. For example, a correlation coefficient may be computed for the two or more time series, and the coefficient may be used as the feature if there are subsequences of two time series from the same sliding window according to some embodiments of the present principles.

In block 422, a fitness score may be generated for each feature so that irrelevant feature may be pruned out before beginning feature series ranking according to the present principles. In one embodiment, after extracting a feature time series (e.g., by transforming raw time series into feature series), a token may be assigned (e.g., right column of Table 1) to the feature time series so that the original time series and related feature series may be retrieved from tokens. For example, the mean feature time series from a time series ‘Series 1’ may be named ‘mean::Series 1’, and the use of tokens may improve processing speed and reduce memory requirements according to some embodiments.

In one embodiment, after feature extraction/time series transformation in block 404, feature series ranking may be performed in block 406 according to the present principles. The original sensor data may be transformed into an expanded set of time series, which may be represented as follows:

x(t)=[x₁(t), [symbol] (t), . . . , [symbol] (t), . . . ,xₙ(t), [symbol] (t), . . . , [symbol] (t)]^{T} (2).

The set may include both the original time series and the transformed feature series x(t)ε [symbol] ^{N} (t=1, . . . , T), N=(m+1) n, where m is the total number of features in the feature library and n is the number of raw time series.

In some embodiments, while feature transformation in block 204 provides an opportunity to generate different time series properties, it poses challenges to accurately select and rank important features (and hence raw time series) because the problems space becomes much larger. In addition, different feature series have correlations, and the relationships between feature series and system quality may therefore no longer be linear. In order to achieve a reliable and stable ranking of feature series, all aspects of feature interactions and their dependencies with respect to the KPI quality may be considered for feature series ranking according to the present principles.

Therefore, rather than relying on a single feature ranking method, an ensemble of feature rankers may be employed in block 424 according to the present principles. The ensemble of feature rankers may include, for example, a regularization based ranker 426, a tree based ranker 428, and/or a nonlinear local structure based ranker 430 according to various embodiments of the present principles.

In block 426, a regularization-based ranker may be employed, for example, to discover regression based relationships according to an embodiment of the present principles. This feature selection strategy may be based on l₁-regularized regression, and may generate a sparse solution with respect to the regression coefficients, and only features with non-zero coefficients may be selected according to various embodiments.

As the output y(t) may be binary in this context, the l₁-regularized regression may be effectively employed. A conditional probability may be formulated as follows:

$$p ( y ( t ) = \pm 1 \vert x ( t ) ) = \frac{1}{1 + exp \{ - y ( t ) {w}^{T} x ( t ) \}} , \qquad ( 3 )$$

and the following penalized negative log-likelihood may be minimized:

$${min}_{w ∈ {ℝ}^{N}} {\sum }_{t = 1}^{T} log [ 1 + exp \{ - y ( t ) {w}^{T} x ( t ) \} ] + λ {‖ w ‖}_{1} , \qquad ( 4 ) ,$$

where ∥w∥₁=Σᵢ₌₁^{N}|wᵢ| is the l₁-norm of regression coefficients, and λ>0 is the regularization parameter. In some embodiments, the optimization problem

$${min}_{w ∈ {ℝ}^{N}} {\sum }_{t = 1}^{T} log [ 1 + exp \{ - y ( t ) {w}^{T} x ( t ) \} ] + λ {‖ w ‖}_{1} ,$$

solved using a variety of techniques, including, for example, using a coordinated descent method according to the present principles.

A problem with l₁-regularized regression may be that the solution can be unstable. For example, if the data is only slightly changed, the selected features may be drastically different in some situations. To address this issue, a subset of input samples may be randomly selected, w may be estimated, and this process may be iterated a plurality of times for various features according to the present principles. The results of all of the independent iterations (e.g., runs) may then be compiled and/or summarized (e.g., condensed), and a final ranking of selected features may be obtained based on the frequency and rank that each of the features shows up during each run.

In block 428, a tree-based ranker may be employed, for example, to estimate the importance of input features based on information theory, thusly providing a feature importance in a different aspect from the regression-based feature selection in block 426.

In one embodiment, the tree-based ranker may split the data sets (e.g., recursively) to build a decision tree, starting from a root node which includes data with all the observation samples. For a node τ in the tree, we search for the best feature x_{f} in equation 2 that leads to a best split of τ. That is, by comparing the values of x_{f} with an optimal cut point, the original node split into two sub-nodes τl and τᵣ containing nl and nᵣ samples respectively.

In one embodiment, the goodness of split may be based on the metric of information gain:

Δx_{f}=i(τ)−p(τₗ)i(τₗ)−p(τᵣ)i(τᵣ), (5)

where p(τₗ)=nₗ/(nₗ+nᵣ) and p(τₗ)=nᵣ/(nₗ+nᵣ). The function i(τ) may represent the Giny impurity measure:

i(τ)=1−p(y=+1|τ)²−p(y=−1|τ)², (6)

in which P(Y=±1|τ) may represent the ratio of positive and negative samples in the node τ, respectively according to the present principles.

In some embodiments, the tree-based ranker may also have stability issues. To address this stability issue, all samples may be divided into B number of subsamples, and B decision trees may be learned from these subsamples, which may lead to a random forest method (e.g., algorithm) for solving. After learning all the trees, the importance of each feature f may be calculated by accumulating the information gain related to that feature, Δxf(τ, b) for all nodes r in all B trees in the forest as:

$${I}_{G} ( {x}_{f} ) = {\sum }_{b = 1}^{B} {\sum }_{τ ∈ {τ}_{b}} Δ {x}_{f} ( τ , b ) , \qquad ( 7 )$$

where τ_{b} is the set of all nodes in tree b.

In block 430, a nonlinear ranker may be employed, for example, to rank features based on the RELIEFF feature selection method. This method may detect nonlinear relationships between features and quality outputs locally according to one embodiment of the present principles. In an exemplary embodiment, each series xf(t) in the feature vector x(t) in equation 2 may be normalized to have zero mean and unit variance. The T samples of feature vector x(t), t=1, . . . , T, may then be divided into a positive set X⁺ and a negative set X⁻ according to their corresponding outputs y(t).

In one embodiment, a feature importance vector, w=[w1 . . . , wN]^{T}, may be included for those N features in vector xₜ in block 430. The RELEIFF feature selection may be performed as an iterative method, and may execute one iteration for each of the T samples of x(t). The weight vector w may be initialized as all zeros at the beginning. In one embodiment, given a sample x(t), the k-nearest neighbors from each X⁺ and X⁻ (e.g., totally 2 k neighbors) may be selected according to the present principles.

In an exemplary embodiment, if each element in X⁺ and X⁻ is denoted as

xₗ⁺=[x_{l,1}⁺, . . . ,x_{l,N}⁺]^{T}

and

xₗ⁻=[x_{l,1}⁻, . . . ,x_{l,N}⁻]^{T},

respectively, where l=1, . . . , k, the importance may be updated as follows:

$${w}_{f} ← \{ \begin{matrix}{w}_{f} - \frac{1}{kN} {\sum }_{𝓁 = 1}^{k} \vert {x}_{f} ( t ) - {x}_{𝓁 , f}^{+} \vert + \frac{1}{kN} {\sum }_{𝓁 = 1}^{k} \vert {x}_{f} ( t ) - {x}_{𝓁 , f}^{-} \vert \\ ( if x ( t ) ∈ {χ}^{+} ) \\ {w}_{f} + \frac{1}{kN} {\sum }_{𝓁 = 1}^{k} \vert {x}_{f} ( t ) - {x}_{𝓁 , f}^{+} \vert - \frac{1}{kN} {\sum }_{𝓁 = 1}^{k} \vert {x}_{f} ( t ) - {x}_{𝓁 , f}^{-} \vert \\ ( if x ( t ) ∈ {χ}^{-} )\end{matrix} \qquad ( 8 )$$

for f=1, . . . , N. Equation 8 illustrates that in some embodiments, the weight of any given feature may decrease if it differs from that feature in nearby instances of the same class more than nearby instances of the other class, and may increase in the reverse scenario according to various embodiments. After iterating through all the T samples, the final importance score for each feature may be determined according to the present principles.

In one embodiment, a goal is to identify the most important time series that affects system quality, and this goal may be achieved by performing ranking score fusion in block 208 according to the present principles. Ranking score fusion 208 may include combining the results of feature rankers (e.g., described with reference to blocks 424, 426, 428, and 430). Such a combination covers at least two aspects of ranking scores. Not only are the feature importance scores aggregated for each sensor, but the score ranking outputs from different rankers may also be combined in block 408. In addition, since the feature ranking scores from different rankers are in different ranges, they may be normalized in block 432 before the fusion process in block 434.

In one embodiment, the three exemplary feature rankers 426, 428, 430 may calculate the importance scores of all features from different perspectives. Therefore, prior to fusing these scores along different rankers in block 434, the ranking scores may be normalized in block 432 to ensure that they are in the same range (e.g., between 0 and 1). In one embodiment, the feature score may be normalized using a sigmoid function according to the present principles. For example, let I be the importance score of a particular ranker, and then its normalized score Î may be calculated as follows:

$$\hat{I} = \frac{1}{1 + exp ( - a ( I - c ) )} \qquad ( 9 )$$

where the parameters a and c may be determined from a distribution of ranking scores for each ranker.

In some embodiments, different sigmoid functions may be employed for the rankers (e.g., 426, 428, 430) during normalization in block 432, each of which may be represented by specific parameters (e.g., (a, c)). The values of these two parameters reflect the shape of sigmoid function, in which a is related to the position of normalization and c relates to the slope of the curve in a graph of a sigmoid function. Their values may be determined based on a calibration process. That is, several synthetic datasets with known ground truth may be generated, and then (a, c) values for each ranker may be set so that their original ranking scores can map to expected values.

In one embodiment, after normalizing the ranking scores in block 432, all feature ranking scores may be combined (e.g., fused) in block 434 to determine important sensors related to quality change. The fusion in block 434 may include two main steps which may combine scores from separate branches, the steps including aggregating the feature importance scores for each sensor in block 436 and combining (e.g., fusing) the score ranking outputs from different rankers in block 438 according to the present principles.

In block 436, the aggregation may aggregate feature importance scores from each sensor, examples of which are illustrated in Table 2 below:

TABLE 2
Feature Importance Scores:

| | (a) Regularization Based | | (b) Tree Based | | (c) Non-Linear | |
|---|---|---|---|---|---|---|
| | Feature | Score | Feature | Score | Feature | Score |
| 1 | PinBin0::21 | 0.4479 | skew::1 | 0.4869 | PinBin0::21 | 0.9661 |
| 2 | ARp1::21 | 0.2375 | PinBin0::21 | 0.2510e−1 | PinBin2::21 | 0.9502 |
| 3 | PinBin2::1 | 0.9253e−1 | ARp1::49 | 0.1474e−1 | PinBin0::1 | 0.9466 |
| 4 | PinBin0::1 | 0.7997e−1 | ARp1::1 | 0.1026e−1 | PinBin2::1 | 0.9444 |
| 5 | ARp1::1 | 0.6899e−1 | qt05::48 | 0.9396e−2 | ARp1::1 | 0.7259 |

In one embodiment, after aggregation in block 436, the resulting aggregated feature importance scores may have values as illustrated in Table 3 below:

TABLE 3
Aggregated Importance Scores

| | (a′) Regularization Based | | (b′) Tree Based | | (c′) Non-Linear | |
|---|---|---|---|---|---|---|
| | Sensor | Score | Sensor | Score | Sensor | Score |
| 1 | 21 | 0.7448 | 1 | 0.5020 | 21 | 2.7371 |
| 2 | 1 | 0.3009 | 21 | 0.3903e−1 | 1 | 2.7081 |
| 3 | 49 | 0.3564e−2 | 49 | 0.1891e−1 | 45 | 0.1940 |
| 4 | 43 | 0.2547e−5 | 48 | 0.1381e−1 | 7 | 0.1723 |
| 5 | 6 | 0.1058e−5 | 39 | 0.6204e−2 | 41 | 0.1023 |

In one embodiment, the aggregated scores from across all rankers (e.g., from Table 3) may be combined (e.g., fused) to obtain the final ranking of sensors according to their fused importance score, an example of which is illustrated in Table 4 below:

TABLE 4
Fused Importance Scores
(d) Fused

| | Sensor | Score |
|---|---|---|
| 1 | 21 | 3.5210 |
| 2 | 1 | 3.5109 |
| 3 | 45 | 0.1940 |
| 4 | 7 | 0.1723 |
| 5 | 41 | 0.1023 |

In one embodiment, the aggregation in block 436 may include the following exemplary steps according to the present principles. For a particular ranker, let Î_{F}_{ⱼ}(xᵢ) and I(xᵢ) be the normalized feature importance score of feature [symbol] and the sensor importance of time series xᵢ, respectively. I(xᵢ) may be calculated as follows:

$$I ( {x}_{i} ) = {\sum }_{j = 0}^{m} {\hat{I}}_{{ℱ}_{j}} ( {x}_{i} ) , \qquad ( 10 )$$

where I_{F}_{₀}(xᵢ) is the importance score of the original time series xᵢ. Essentially, the combined score for each sensor may be represented as the summation of scores from its features according to the present principles.

In one embodiment, the combining (e.g., fusion) in block 438 may include the following exemplary steps according to the present principles. For example, let I_{reg}(xᵢ), Iₜᵣₑₑ(xᵢ), and Iₙₒₙ(xᵢ) be the sensor importance score for the sensor xᵢ of the regularization based ranker, tree based ranker, and nonlinear ranker, respectively. Let I_{fused}(xᵢ) denote the overall (fused) importance score for the sensor xᵢ. In one embodiment, I_{fused} may be calculated as follows:

I_{fused}(xᵢ)=wᵣI_{reg}(xᵢ)+wₜIₜᵣₑₑ(xᵢ)+wₙIₙₒₙ(xᵢ), (11)

where wᵣ, wₜ, and wₙ are the weights associated with each ranker, respectively.

In some embodiments, separate validation data may be employed to determine the above weights according to the present principles. For example, a classifier based on the top features discovered by each ranker may be built, and the classifier may be employed to evaluate the evaluation data. The value of w* may represent the accuracy of validation for each ranker. Various classifiers may be employed according to the present principles, including, for example, employing a support vector machine (SVM) as the classifier for validation.

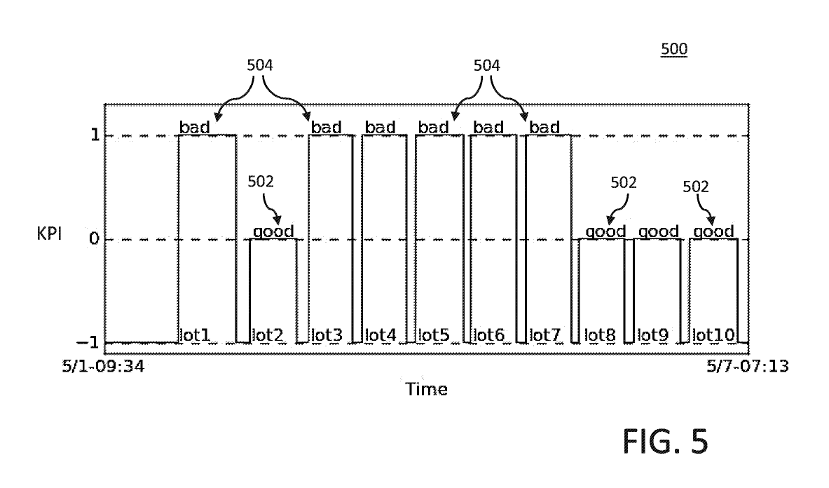

Referring now to FIG. 5, an exemplary key performance index (KPI) time series 500 for a biochemical plant is illustratively depicted in accordance with an embodiment of the present principles. It is noted that the KPI time series 500 for a biochemical plant is presented for simplicity of illustration, and that the present principles may be applied to any physical systems according to various embodiments.

In one embodiment, the present principles may be applied to a data set from a process of a biochemical plant for a particular seasoning product. The system of this plant may have seven sensors labeled ‘I’, ‘J’, ‘K’, ‘L’, ‘M’, ‘N’ and ‘O’. Each sensor records a system status every minute. The KPI time series of this data set is shown in FIG. 5, and each bump 502, 504 represents the executing the process for each lot, and the KPI value shows the quality of products and/or whether the process is working or not working according to various embodiments. For example, the products have some anomalies if the corresponding KPI is 1, the products are normal if the corresponding KPI is 0 and the process is not active in the time region where the KPI is −1.

In one embodiment, the quality regions may be assigned according to this KPI. That is, the time regions where KPI=0 are assigned to good quality regions 502, and bad quality regions 504 where KPI=1. For this system the sensors which are related to the KPI are located among the plurality of sensors in the physical system according to the present principles. Table 5, below, shows the final result of the method and sensor ‘J’ is found as the most important relevant feature. In practice, this is the key sensor (e.g., according to a domain expert of this plant). However, it is not possible to determine why this sensor is important only by this result, so intermediate feature ranking results of each rankers are analyzed according to the present principles.

TABLE 5
Result of the Sensor Ranking:

| Rank | Sensor | Score |
|---|---|---|
| 1 | J | 3.1587 |
| 2 | L | 1.1897 |
| 3 | I | 0.8146 |

In one embodiment, Table 6, below, may show the results of the top features from each ranker:

TABLE 6
Feature Ranking for Each Ranker:

| | (a) Regularization | | (b) Tree Based | | (c) Non-Linear | |
|---|---|---|---|---|---|---|
| | Feature | Score | Feature | Score | Feature | Score |
| 1 | kurt::J | 1.0000 | kurt::J | 1.0000 | kurt::J | 0.3434e−1 |
| 2 | PinBin0::J | 0.9860 | skew::J | 0.2279e−1 | skew::J | 0.2076e−2 |
| 3 | ARp1::L | 0.9586 | std::J | 0.6294e−2 | std::L | 0.8785e−3 |
| 4 | qt05::I | 0.8000 | qt05::I | 0.2982−2 | qt05::L | 0.8297e−3 |
| 5 | PinBin1::K | 0.3000 | skew::K | 0.2804−2 | FmxLoc::L | 0.7446e−3 |

As shown in Table 6, the feature ‘kurt::J’ (e.g., kurtosis of sensor ‘J’) is determined to be the most important feature for all rankers in this real physical system (e.g., biochemical plant) according to the present principles. The feature series ‘kurt::J’ may change almost at the same time as the KPI, and as such, it is impossible to identify such synchronized changes directly from the original time series (e.g., without transformation, ranking, and fusion according to the present principles).

As shown in the real-world example above, the present principles may be employed to determine the most important time series and the most important features (e.g., which are related to the KPI) of real physical systems (e.g., a biochemical plant) according to various embodiments. In some embodiments, a graphical user interface (GUI) may be constructed, and may show an image of output for the quality control engine (e.g., results may be obtained by a simple click after inputting time series data and a corresponding KPI), and the GUI of the quality control engine may be employed to adjust the settings of the physical system to improve quality (e.g., based on the output of the quality control engine) according to various embodiments of the present principles.

Referring now to FIG. 6, an exemplary system 600 for quality control for physical systems using a quality control engine is illustratively depicted in accordance with an embodiment of the present principles.

While many aspects of system 600 are described in singular form for the sakes of illustration and clarity, the same can be applied to multiples ones of the items mentioned with respect to the description of system 600. For example, while a single controller 680 is illustratively depicted, more than one controller 680 may be used in accordance with the teachings of the present principles, while maintaining the spirit of the present principles. Moreover, it is appreciated that the controller 680 is but one aspect involved with system 600 than can be extended to plural form while maintaining the spirit of the present principles.

The system 600 may include a bus 601, a data collector 610, a time series transformer 620, a feature sequence extractor 622, a fitness score generator 624, a feature library/storage device 630, feature series rankers 640, a ranking score fusion device/data condenser 650, a normalizer 652, an aggregator 654, a combiner/fuser 656, a classifier/validator 660, a GUI display 670, and/or a controller 680 according to various embodiments of the present principles.

In one embodiment, the data collector 610 may be employed to collect raw data (e.g., sensor data, time series, system operational status, etc.), and the raw data may be received as input to a time series transformer 620. The time series transformer 620 may transform raw time series into a number of feature series to cover various aspects of the dynamics of sensor readings, including, for example, characteristics of time series in the temporal domain/frequency domain, temporal dependencies of individual time series/different time series according to various embodiments, which may be included in a feature library 630. A sliding window technique may be employed by a feature sequence extractor 622 to extract a sequence of features (rather than individual feature values), and a fitness score generator 624 may be generated for each feature to prune out irrelevant features before employing feature series rankers 640.

In one embodiment, an ensemble of feature series rankers 640 may be employed to cover all aspects of feature dependencies, including, for example, a regularization based ranker, a tree based ranker, and/or a nonlinear ranker according to the present principles. A ranking score fusion device 650 may include a normalizer 652 to normalize scores from different rankers, an aggregator 654 to aggregate feature importance scores for each sensor, and/or a combiner/fuser 656 to combine the score ranking outputs from different rankers according to the present principles.

In one embodiment, a classifier 660 may be built based on top features discovered by each ranker, and the classifier 660 may be employed to evaluate validation data (e.g., for weights associated with each ranker). A GUI display 670 may be provided, and may include raw data, KPI time series, etc., and a controller 680 may be employed to adjust the system based on the output of the quality control system 600 including a quality control engine according to various embodiments of the present principles.

It should be understood that embodiments described herein may be entirely hardware or may include both hardware and software elements, which includes but is not limited to firmware, resident software, microcode, etc. In a preferred embodiment, the present invention is implemented in hardware.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for quality control for a physical system, comprising:
transforming raw time series data collected from each of a plurality of sensors in the physical system into one or more sets of feature series by extracting features from the raw time series;
generating feature ranking scores for each of the sensors by ranking each of the features using an ensemble of feature rankers;
generating fused importance scores by aggregating the feature ranking scores for each of the sensors and combining ranking scores from each ranker in the ensemble; and
controlling system quality by identifying sensors responsible for quality degradation based on the fused importance scores.

2. The method as recited in claim 1, wherein the ensemble of feature rankers considers a plurality of aspects of feature interactions and their dependencies to generate the feature ranking scores for each of the sensors.

3. The method as recited in claim 1, wherein the ensemble of feature rankers includes at least one of a regularization-based ranker, a tree-based ranker, or a nonlinear ranker.

4. The method as recited in claim 1, wherein the physical system is a physical manufacturing system.

5. The method as recited in claim 1, wherein a sliding window technique is employed during the transforming to extract the features while preserving continuity along a time axis.

6. The method as recited in claim 1, wherein the features are stored in a pre-defined library, the library including a plurality of feature definitions describing different aspects of signal dynamics.

7. The method as recited in claim 6, wherein the different aspects include at least one of characteristics of time series in a temporal domain, characteristics of time series in a frequency domain, temporal dependencies of individual time series, or temporal dependencies across different time series.

8. The method as recited in claim 1, wherein the feature ranking scores are normalized using a sigmoid function before generating the fused importance scores.

9. A quality control engine for a physical system, comprising:
a time series transformer for transforming raw time series data collected from each of a plurality of sensors in the physical system into one or more sets of feature series by extracting features from the raw time series;
an ensemble of feature rankers configured to rank each of the features to generate feature ranking scores for each of the sensors;
a combiner for generating fused importance scores by aggregating the feature ranking scores for each of the sensors and fusing ranking scores from each ranker in the ensemble; and
a controller for managing system quality by identifying sensors responsible for quality degradation based on the fused importance scores.

10. The system as recited in claim 9, wherein the ensemble of feature rankers considers a plurality of aspects of feature interactions and their dependencies to generate the feature ranking scores for each of the sensors.

11. The system as recited in claim 9, wherein the ensemble of feature rankers includes at least one of a regularization-based ranker, a tree-based ranker, or a nonlinear ranker.

12. The system as recited in claim 9, wherein the physical system is a physical manufacturing system.

13. The system as recited in claim 9, wherein a sliding window technique is employed during the transforming to extract the features while preserving continuity along a time axis.

14. The system as recited in claim 9, wherein the features are stored in a pre-defined library, the library including a plurality of feature definitions describing different aspects of signal dynamics.

15. The system as recited in claim 14, wherein the different aspects include at least one of characteristics of time series in a temporal domain, characteristics of time series in a frequency domain, temporal dependencies of individual time series, or temporal dependencies across different time series.

16. The system as recited in claim 9, wherein the feature ranking scores are normalized using a sigmoid function before generating the fused importance scores.

17. A computer-readable storage medium including a computer-readable program, wherein the computer-readable program when executed on a computer causes the computer to perform the steps of:
transforming raw time series data collected from each of a plurality of sensors in the physical system into one or more sets of feature series by extracting features from the raw time series;
generating feature ranking scores for each of the sensors by ranking each of the features using an ensemble of feature rankers;
generating fused importance scores by aggregating the feature ranking scores for each of the sensors and combining ranking scores from each ranker in the ensemble; and
controlling system quality by identifying sensors responsible for quality degradation based on the fused importance scores.

18. The computer-readable storage medium as recited in claim 17, wherein the ensemble of feature rankers considers a plurality of aspects of feature interactions and their dependencies to generate the feature ranking scores for each of the sensors

19. The computer-readable storage medium as recited in claim 17, wherein the ensemble of feature rankers includes at least one of a regularization-based ranker, a tree-based ranker, or a nonlinear ranker.

20. The computer-readable storage medium as recited in claim 17, wherein a sliding window technique is employed during the transforming to extract the features while preserving continuity along a time axis.
